(19) United States
(12) Patent Application Publication
(10) Pub. No.: US 2011/0052968 A1
(43) Pub. Date: Mar. 3, 2011

(54) BATTERY PACK ASSEMBLY AND RELATED PROCESSES

(75) Inventors: Venkat Subramaniam Venkataramani, Clifton Park, NY (US); Mohamed Rahmane, Ballston Lake, NY (US)

(73) Assignee: GENERAL ELECTRIC COMPANY, SCHENECTADY, NY (US)

(21) Appl. No.: 12/549,877

(22) Filed: Aug. 28, 2009

(51) Int. Cl. H01M 6/42; H01M 4/82

(52) U.S. Cl. 429/158; 429/156; 29/623.5

(57) ABSTRACT

A battery pack assembly is described. The battery pack assembly includes a plurality of electrochemical cells, wherein the electrochemical cells are isolated from each other by a high temperature electrically insulating coating applied to an outer surface of each electrochemical cell. Methods for providing electrical isolation between individual electrochemical cells are also described.

### BACKGROUND

The invention relates generally to an electrically insulating coating. More particularly, the invention relates to a high temperature electrically insulating coating for electrical isolation of sodium cells in a battery pack assembly. The invention also relates to a method of making such a battery pack.

Batteries are essential components used to store a portion of the energy in mobile systems such as electric vehicles, hybrid electric vehicles and non-vehicles (for example locomotives, off-highway mining vehicles, marine applications, buses and automobiles) and for stationary applications such as uninterruptible power supply (UPS) system and “Telecom” (telecommunication systems). In the case of vehicles, the energy is often regenerated during braking, for later use during motoring. In general, energy can be generated when the demand is low, for later use, thus reducing fuel consumption. In general, battery operating environments are harsh for several reasons, including, but not being limited to, large changes in environmental operating temperature, extended mechanical vibrations, and the existence of corrosive contaminants.

In addition, charge and discharge are accomplished under severe conditions, including large amounts of discharging current at the time of acceleration of a heavy vehicle, and large amounts of charging current at the time of braking. Nevertheless, given the high initial capital cost, hybrid vehicle batteries are usually expected to have an extended lifetime. Normally, these batteries are made up of many cells. Each cell is electrically isolated from the adjacent cells while, at the same time, the cells are electrically connected to each other in series or in parallel arrangement. Typically, the individual cells are separated by a mica sheet or micacious wraps or foils placed between the cells for electrical insulation.

Many different types of batteries are known to exist. However, as understood by those of ordinary skill, current high-temperature batteries, such as, for example, sodium metal halide batteries, are prone to failure due to mechanical vibration damage to the battery. Mechanical vibrations cause relative motion between the mica sheets and the cells, leading to a loss in electrical connection between cells, due to electrical creep. The vibrations can also lead to strike failures in tight spaces, and can lead to damage of the mechanical and insulating properties of the mica sheets.

It would therefore be desirable to develop a battery pack of high reliability and extended lifetime, with improved electrical insulation to be used in high vibration environments for hybrid transportation vehicles, such as locomotives.

### BRIEF DESCRIPTION

According to some embodiments of the present invention, a battery pack assembly, including a plurality of electrochemical cells, is provided. The electrochemical cells are isolated from each other by a high-temperature, electrically-insulating coating applied to an outer surface of the electrochemical cells.

Some embodiments of the present invention further provide a method for providing electrical isolation between individual electrochemical cells in a battery pack assembly. The method includes the step of applying a coating of a high-temperature insulating material to an outer surface of the cells by a high temperature thermal deposition process. The melting point of the high-temperature insulating material is greater than the operational temperature of the electrochemical cell.

### DRAWINGS

These and other features, aspects, and advantages of the present invention will become better understood when the following detailed description is read with reference to the accompanying drawings, wherein:

FIG. 1 is a schematic of an embodiment of the present invention;

FIG. 2 is a schematic of another embodiment of the present invention;

### DETAILED DESCRIPTION

As discussed in detail below, some of the embodiments of the present invention provide a high temperature electrically insulating coating for the electrical isolation of individual electrochemical cells in a battery pack. These embodiments advantageously avoid the risk of damaging electrical insulation between the cells during operation. The embodiments of the present invention also describe a method of applying such a high temperature coating on an outer surface of each cell. Though the present discussion provides examples in the context of coatings for a battery, one of ordinary skill in the art will readily comprehend that the application of these coatings in other contexts, such as for thermal barrier coatings, or corrosion barrier coatings, is well within the scope of the present invention.

The present invention will be described with respect to a battery pack for use with a mobile system. However, the present invention is equivalently applicable to other types of batteries operable at high temperatures, typically more than about 250 degrees Celsius. Additionally, the present invention may be used with stationary applications, such as uninterruptible power supply (UPS) systems, and telecommunication systems.

Approximating language, as used herein throughout the specification and claims, may be applied to modify any quantitative representation that could permissibly vary, without resulting in a change in the basic function to which it is related. Accordingly, a value modified by a term or terms, such as “about”, is not limited to the precise value specified. In some instances, the approximating language may correspond to the precision of an instrument for measuring the value.

As used herein, “cathodic material” is the material that supplies electrons during charge, and is present as part of a redox reaction. “Anodic material” accepts electrons during charge, and is present as part of the redox reaction.

The term “electrically isolated” as used herein means that each electrochemical cell in the battery pack assembly is electrically separated from adjacent cells, with respect to cells arranged side by side.

As used herein, “breakdown strength” refers to a measure of the dielectric breakdown resistance of a material under an applied AC or DC voltage. The applied voltage prior to breakdown is divided by the thickness of the material, to provide the breakdown strength value. It is generally measured in units of potential difference over units of length, such as kilovolts per millimeter (kV/mm). As used herein, the term “high temperature” generally refers to temperatures above about 250 degrees Celsius (° C.), unless otherwise indicated.

According to one embodiment of the invention, a battery pack assembly is provided. The battery pack assembly includes a plurality of electrochemical cells, being electrically isolated by a high-temperature electrically insulating coating applied to an outer surface of each electrochemical cell.

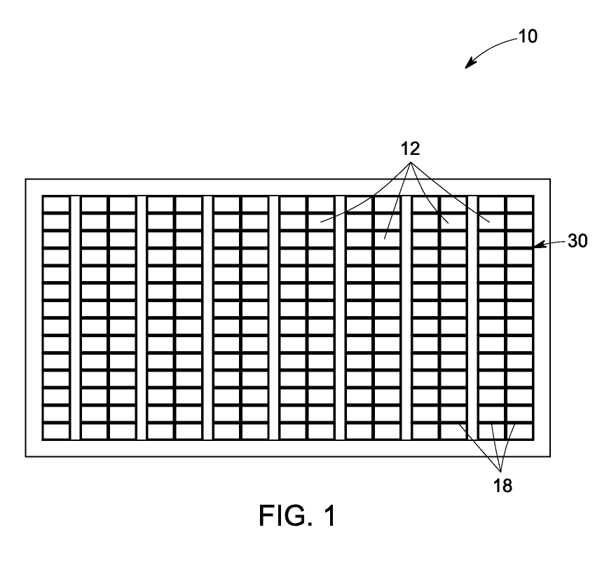

FIG. 1 illustrates an exemplary view of a battery pack assembly 10 in accordance with one embodiment of the invention. In the illustrated embodiment, the battery pack 10 includes a plurality of electrochemical cells 12. The cells 12 are electrically connected to each other in series and in parallel arrangement. The number of cells and their electrical arrangement, typically, depend on the output requirement of the battery pack, and on the end use application. The cells 12 are stacked adjacent to each other in the pack. Each cell 12 has an outer surface 18, a portion of which is in contact with the adjacent cells. Each cell 12 is electrically isolated from the adjacent cells by a high temperature electrically insulating coating 30, applied to the outer surface 18 of each cell 12 or on at least one facing surface, as mentioned below.

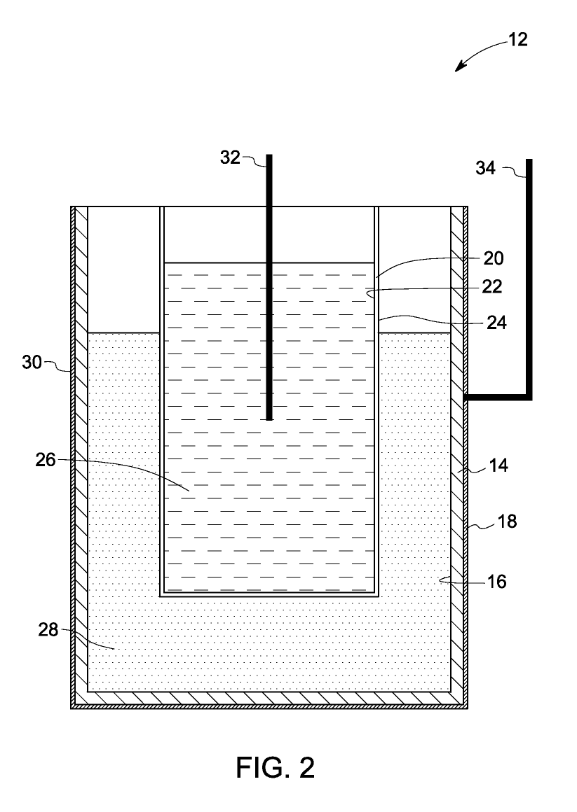

A schematic of one of the cells 12 of FIG. 1 is shown in FIG. 2. The electrochemical cell 12 comprises a metallic casing 14 having an inner surface 16 and an outer surface 18. The cell 12, further comprises a separator 20 having a first surface 22 and a second surface 24. The first surface 22 defines at least a portion of a first chamber 26, and the second surface 24 defines a second chamber 28. The first chamber 26 is disposed within the second chamber 28. The first chamber 26 is in ionic communication with the second chamber 28, through the separator 20. The outer surface 18 of the metallic casing 14 is coated with a high temperature electrically insulating coating 30. In this embodiment, the first chamber 26 and the second chamber 28 further include current collectors 32 and 34 to collect the current produced by the electrochemical cell.

The metallic casing 14 is, generally, a container, and defines the second chamber 28, between the inner surface 16 of the casing 14 and the second surface 24 of the separator 20. Suitable metallic materials for the metallic casing may be selected from the group consisting of nickel, mild steel, stainless steel, nickel-coated steel, molybdenum and molybdenum-coated steel, as examples.

To electrically isolate an individual electrochemical cell in the battery pack, each cell is separated from an adjacent cell by applying a high-temperature insulating coating on the outer surface 18 of the cells. It should be understood that in some embodiments, which are exemplified primarily here, the coating is applied to an outer surface of each electrochemical cell. However, in other embodiments, the coating might be applied to an outer surface of one cell, which may sometimes be sufficient to insulate the cell from a facing surface of an adjacent cell, which is not provided with the coating. Furthermore, the coating may be applied to other surfaces as well, depending in part on the coating application technique. As an example, the coating could be applied on the inner surface 16 of the metallic casing 14. In that instance, at least one current collector would probably be incorporated into some portion of the anode structure. Application of the coating to these other surfaces can sometimes be advantageous from a process standpoint, because various masking steps that are sometimes necessary can be eliminated.

The insulating coating is sustainable at high temperatures, that is, at least at the operating temperature of the electrochemical cell. The electrochemical cell may operate in a temperature range of from about 250 to about 400 degrees Celsius. In a preferred embodiment, the operating temperature of the cell may be in a range of from about 270 degrees Celsius to about 350 degrees Celsius. In certain embodiments, the operating temperature may reach up to about 400 degrees Celsius. To satisfy the high temperature and safety requirements, an insulating material is selected for the insulating coating that has a melting point of at least about 500 degrees Celsius. In one embodiment, the insulating material has a melting point in a range from about 500 degrees Celsius to about 600 degrees Celsius.

Suitable high temperature insulating materials may include, but are not limited to, a ceramic, a glass, an enamel, a high temperature polymer, or a combination thereof. In one embodiment, the ceramic material includes an oxide, a carbide or a nitride. In an exemplary embodiment, the ceramic material is alumina.

A variety of polymers may be suitable at high temperatures, and are referred as “high temperature polymers”. These polymers typically, have their glass transition temperatures above about 200 degrees Celsius, and their melting/decomposition temperatures above about 300 degrees Celsius. Non-limiting examples of the high-temperature insulating polymers include silanes, silazanes, polyether ether ketone (PEEK), polyimides and modified polyimides (polyimide varnishes), such as cyano modified polyimides and silicone modified polyimides; cyanate esters, biamaleimides, phenolics (e.g., engineered phenolics), melamines, urea formaldehydes and various copolymers which contain any of the foregoing.

In a preferred embodiment, the high temperature insulating polymers are polyimide varnishes, phenolic formaldehyde based varnishes, polysilazane based resins such as HTT 1800 (from KION Corporation), polysilazane block copolymers (CERASET® SN preceramic polymer, Lanxide Corporation, Newark, Del.), modified polyether ether ketones (PEEK), and cyanate esters. Various polyimide varnishes can be used, in which a polyamic acid is dissolved in an organic solvent. Specific, non-limiting examples of such varnishes include TORAYNEECE (from Toray Industries Inc.), U-varnish (from Ube industries, Ltd.), RIKACOAT (from New Japan Chemical Co., Ltd.), OPTOMER (from Japan Synthetic Rubber Co., Ltd.), SE812 (from Nissan Chemical Industries, Ltd.), and CRC8000 (from Sumitomo Bakelite Co., Ltd).

In another embodiment, the polymer is a polymer composite. As used herein, the term “composite” is meant to refer to a material made of more than one component. Thus, in this embodiment, the polymer or copolymer contains at least one inorganic constituent e.g., a filler material. The polymer can be selected from the higher-temperature polymers set forth above. The filler material can be one of the ceramic materials discussed above. The ceramic material can be in a variety of shapes or forms, e.g., particulates, fibers, platelets, whiskers, rods, or a combination of two or more of the foregoing. In one embodiment, the ceramic material (e.g., a particle) may be used in a form with a specified particle size, particle size distribution, average particle surface area, particle shape, and particle cross-sectional geometry. (Other specifications may also be adhered to, depending on the type of constituent, e.g., an aspect ratio in the case of whiskers or rods).

In one embodiment, the ceramic material may be present in the polymer composite in an amount from about 1 weight percent to about 80 weight percent, based on the total weight of the polymer composite. In another embodiment, the ceramic material may be present in an amount from about 5 weight percent to about 60 weight percent, based on the total weight of the polymer composite. In yet another embodiment, the ceramic material may be present in an amount from about 10 weight percent to about 50 weight percent, based on the total weight of the polymer composite.

The high-temperature insulating coating is expected to have robustness and long life in a harsh environment. The coating is resistant to harsh mechanical conditions, and does not crack or abrade due to vibrations or shocks in a mobile system such as locomotives and buses. Besides electrical isolation, the insulating coating further provides corrosion protection to the electrochemical cell, in some embodiments. During an operation, molten sodium may leak out of the outer surface of the casing. Application of the high temperature insulating coating prevents abrasion (which can lead to the leakage) and in turn, prevents a potential corrosion problem in the cell. Thus, the high-temperature insulating coatings provide vibration absorbance, abrasion resistance, and electrical isolation between the cells.

The above-discussed properties of the coating depend on various parameters such as the thickness of the coating, the method of deposition, the material used for the coating, etc. In one embodiment, the thickness of the high-temperature insulating coating is in a range from about 50 microns to about 1 mm, and in some specific embodiments, from about 100 microns to about 500 microns. In one embodiment, the high-temperature insulating coating has a breakdown voltage (or dielectric strength) of at least about 10 kV/mm. In one embodiment, the hardness number of the coating is in a range from about 100 HV to about 2000 HV.

The separator 20 is disposed within the metallic casing 14. The separator may have a cross-sectional profile normal to the axis that is a circle, a triangle, a square, a cross, or a star.

The separator is usually an alkali metal ion conductor solid electrolyte that conducts alkali metal ions during use. Suitable materials for the separators may include alkali-metal-beta′-alumina, alkali-metal-beta″-alumina, alkali-metal-beta′-gallate, or alkali-metal-beta″-gallate. In one embodiment, the separator includes a beta“alumina. In one embodiment, a portion of the separator comprises alpha alumina, and another portion of the separator comprises beta” alumina. The alpha alumina may be relatively more amenable to bonding (e.g., compression bonding) than beta alumina, and may help with sealing and/or fabrication of the cell.

The separator 20 can be a tubular container in one embodiment, having a first surface 22 and a second surface 24. The separator is characterized by a selected ionic conductivity. The resistance of the separator (i.e., across its thickness) may depend in part on the thickness itself. A suitable thickness can be less than about 5 millimeters. In one embodiment, the thickness of the separator is in a range of from about 0.5 millimeter to about 5 millimeters. In a preferred embodiment, the thickness of the separator is in a range of from about 1 millimeter to about 2 millimeters.

An alkali metal ion is transported across the separator 20 between the first chamber 26 and the second chamber 28 in one embodiment. Suitable ionic materials may include one or more of sodium, lithium and potassium. The alkali metal is an anodic material. In one embodiment, the anodic material is sodium. At least the first chamber or the second chamber may receive and store a reservoir of the anodic material. The anodic material is usually molten during use. Additives suitable for use in the anodic material may include a metal oxygen scavenger. Suitable metal oxygen scavengers may include one or more of manganese, vanadium, zirconium, aluminum, or titanium. Other useful additives may include materials that increase wetting of the separator surface by the molten anodic material. Additionally, some additives may enhance the contact or wetting of the separator with regard to the current collector, to ensure substantially uniform current flow throughout the separator.

In one embodiment, the electrochemical cell 12 is a sodium metal halide cell. The first chamber may contain a cathodic material and the second chamber may contain the anodic material. The cathodic material may exist in elemental form or as a salt, depending on a state of charge (i.e., in regard to the ratio of the forms of material which are present). The cathodic material may contain an alkali metal, and the salt form of the cathodic material may be a halide. Suitable materials for use as the cathodic material may include aluminum, nickel, zinc, copper, chromium, tin, arsenic, tungsten, molybdenum, iron, and various combinations thereof. The halide of the alkali metal may be chlorine, fluorine, bromine, iodine, or various combinations thereof.

In one embodiment, at least two cathodic materials may be used, i.e., a first cathodic material and a second cathodic material. The first cathodic material may include aluminum, nickel, zinc, copper, chromium, and iron. The second cathodic material is different from the first cathodic material, and may also be selected from aluminum, nickel, zinc, copper, chromium, and iron. Other suitable second cathodic materials are tin, arsenic, tungsten, titanium, niobium, molybdenum, tantalum, vanadium, and various combinations thereof. The first cathodic material may be present relative to the second cathodic material by a ratio of less than about 100:1. In one embodiment, the first cathodic material may be present relative to the second cathodic material by a ratio that is in a range from about 100:1 to about 50:1. In another embodiment, the first cathodic material may be present relative to the additive metals by a ratio that is in a range from about 50:1 to about 1:1. In yet another embodiment, the first cathodic material may be present relative to the additive metals by a ratio that is in a range from about 1:1 to about 1:95.

The cathodic material can be self-supporting or liquid/molten. In one embodiment, the cathodic material is disposed on an electronically conductive support structure. The support structure can be in a number of forms, such as a foam, a mesh, a weave, a felt, or a plurality of packed particles, fibers, or whiskers. In one embodiment, a suitable support structure may be formed from carbon. An exemplary carbon form is reticulated foam. The support structure may also be formed from a metal.

The cathodic material can be secured to an outer surface of the support structure. In some instances, the support structure can have a high surface area. The cathodic material on the support structure may be adjacent to the first surface of the separator, and extend away from that separator surface. The support structure can extend away from the first surface to a thickness that is greater than about 0.01 millimeter. In one embodiment, the thickness is in a range of from about 0.01 millimeter to about 1 millimeter. In one embodiment, the thickness is in a range of from about 1 millimeter to about 20 millimeters. For larger capacity electrochemical cells, the thickness may be larger than 20 millimeters.

A sulfur or a phosphorous-containing additive may be disposed in the cathodic material. For example, elemental sulfur, sodium sulfide or triphenyl sulfide may be disposed in the cathode. The presence of these additives in the cathode may reduce or prevent recrystallization of salts, and grain growth.

In another embodiment, the electrochemical cell 12 is a sodium-sulfur cell. In this embodiment, the first chamber contains the anodic material that is sodium, and the second chamber contains the cathodic material. The cathodic material is usually sulfur.

As discussed above, the electrochemical cell 12 has current collectors, 32 and 34, including an anode current collector and a cathode current collector. The anode current collector is in electrical communication with the anodic material, and the cathode current collector is in electrical communication with the cathode material, or with the respective chambers. Suitable materials for the anode current collector may include W, Ti, Ni, Cu, Mo or combinations of two or more thereof. Carbon can also be used. The cathode current collector may be a wire, paddle or mesh, usually formed from Pt, Pd, Au, Ni, Cu, C, or Ti. The current collector may be plated or clad. The anode current collector and cathode current collector usually have a thickness greater than about 1 millimeter (mm).

The first and the second chambers 26 and 28 can be sealed to the separator 20 by a sealing structure (not shown in drawings), for example a gasket, a sealing strip or a sealing composition. The sealing structure provides separation between the contents of the cell and the environment, and also prevents leakage and contamination. Also, the sealing structure isolates the first chamber and the second chamber from the outside environment, and from each other.

The sealing structure can be a glassy composition, a cermet or a combination thereof, as examples. Suitable glassy sealing compositions may include, but are not limited to phosphates, silicates, borates, germanates, vanadates, zirconates, and arsenates. These materials can be employed in various forms, for example, borosilicates, aluminosilicate, calcium silicate, binary alkali silicates, alkali borates, or a combination of two or more thereof. The cermet may contain alumina and a refractory metal. Suitable refractory metals may include one or more of molybdenum, rhenium, tantalum or tungsten. Alternatively, the end portions of the separator may include alpha alumina. The alpha alumina can be bonded directly to the lid that encloses the second chamber. Suitable bonding methods may include thermal compression bonding, diffusion bonding, or thin film metallizing. Each of these methods may be used in conjunction with welding or brazing techniques.

The sealing structure is capable of remaining intact at elevated temperatures. Each of the first chamber 26 and the second chamber 28 is usually sealed at a temperature greater than about 300 degrees Celsius. In one embodiment, the operating temperature range for the battery pack assembly is from about 250 to 400 degrees Celsius. In some preferred embodiments, the operating temperature of the battery pack may vary in a range from about 270 degrees Celsius to about 350 degrees Celsius. In certain embodiments, the operating temperature of the battery pack may be as high as about 400 degrees Celsius. The separator does not etch or pit in the presence of a halogen and the anodic material.

According to an embodiment of the invention, a method of providing electrical isolation between individual electrochemical cells in a battery pack is provided. The method involves the step of applying a coating of a high-temperature insulating material to an outer surface of the cells - usually (though not always) - to each cell. The melting point of the high-temperature insulating material is greater than the operational temperature of the battery pack. The high-temperature insulating coating is applied by a high temperature thermal deposition process.

A variety of deposition techniques can be used for deposition of the high temperature insulating coating. Examples of suitable high temperature thermal deposition processes include, but are not limited to, a plasma spray process, an HVOF (High Velocity Oxy-Fuel) spray process, a liquid flame spray process, and a cold spray process. In an exemplary embodiment, the plasma spray deposition is an air plasma spray (APS) deposition process. In some embodiments, the high temperature insulating coating is a ceramic coating as discussed above. In those embodiments, precursor based deposition techniques may be used. The precursor may be a sol, a jel, a sol solution, a sol-jel, or a particle-filled precursor. The coating may be carried out under heat treatment after deposition. For example, aluminum may be mixed in a suitable solvent such as n-butanol, n-propanol, or isopropanol, to form a suitable precursor (e.g., the corresponding alkoxide). Alternatively, an organometallic compound containing aluminum may be used as a precursor. The coating may be deposited by a suitable liquid precursor based spray technique and heat-treated to form a dense oxide, alumina.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A battery pack assembly, comprising:
a plurality of electrochemical cells, being electrically isolated from each other by a high temperature electrically-insulating coating applied to an outer surface of the electrochemical cells.

2. The battery pack assembly of claim 1, wherein the plurality of electrochemical cells are electrically connected in series, in parallel, or in a combination of series and parallel arrangements.

3. The battery pack assembly of claim 1, wherein the outer surface of the electrochemical cell comprises a metallic casing.

4. The battery pack assembly of claim 3, wherein the metallic casing comprises a metallic material selected from the group consisting of nickel, mild steel, stainless steel, nickel-coated steel, molybedenum and molybedenum-coated steel.

5. The battery pack assembly of claim 1, wherein the high temperature electrically insulating coating comprises a ceramic, an enamel, a high temperature insulating polymer, or a combination thereof.

6. The battery pack assembly of claim 5, wherein the ceramic comprises an oxide, a carbide or a nitride.

7. The battery pack assembly of claim 5, wherein the high temperature insulating polymer is a polymer selected from the group consisting of silanes, silazanes, polyether ether ketone (PEEK), polyimides, phenolics, melamine, and urea formaldehydes.

8. The battery pack assembly of claim 1, wherein the insulating material has a melting point of at least about 500 degree Celsius.

9. The battery pack assembly of claim 1, wherein the thickness of the coating is in a range of from about 50 microns to about 1 mm.

10. The battery pack assembly of claim 9, wherein the thickness of the coating is in a range of from about 100 microns to about 500 microns.

11. The battery pack assembly of claim 1, wherein the breakdown voltage of the coating is at least about 10 kV/mm.

12. The battery pack assembly of claim 1, wherein the hardness number of the coating is in a range of from about 100 to about 2000 HV.

13. The battery pack assembly of claim 1, wherein each electrochemical cell comprises a first chamber, a second chamber and a separator, the separator having a first surface that defines at least a portion of the first chamber, and a second surface that defines a second chamber, and the first chamber is in ionic communication with the second chamber through the separator.

14. The battery pack assembly of claim 13, wherein the first chamber is electronically insulated from the second chamber.

15. The battery pack assembly of claim 13, wherein the first chamber is disposed within the second chamber.

16. The battery pack assembly of claim 13, wherein the separator is an alkali-metal-ion conductor, and comprises at least one of alkali-metal-beta-alumina, alkali-metal-beta″-alumina, alkali-metal-beta-gallate, or alkali-metal-beta″-gallate.

17. The battery pack assembly of claim 1, wherein the electrochemical cell is a sodium metal halide cell.

18. The battery pack assembly of claim 1, wherein the electrochemical cell is a sodium-sulfur cell.

19. The battery pack assembly of claim 13, wherein at least the first chamber or the second chamber comprises an anodic material which itself comprises sodium.

20. A method for providing electrical isolation between individual electrochemical cells in a battery pack assembly, comprising the step of applying a coating of a high-temperature insulating material to an outer surface of each cell by a high temperature thermal deposition process, wherein the melting point of the high-temperature insulating material is greater than the operational temperature of the electrochemical cell.

21. The method of claim 20, wherein the high temperature thermal deposition process is a plasma spray process, an HVOF (High Velocity Oxy-Fuel) process, or a cold spray process.
